(19) United States
(12) Patent Application Publication
(10) Pub. No.: US 2011/0049354 A1
(43) Pub. Date: Mar. 3, 2011

(54) METHOD AND DEVICE FOR DETECTING AT LEAST ONE TARGET SUBSTANCE

(76) Inventors: Matthias Englmann, Augsburg (DE); Phillippe Schmitt-Kopplin, Freising (DE); Istvan Gebefuegi, Muenchen (DE); Heinz Frisch, Karisfeld (DE); Wolfgang Dietz, Neufahrn (DE)

(21) Appl. No.: 12/768,023

(22) Filed: Apr. 27, 2010

Related U.S. Application Data
(63) Continuation of application No. PCT/EP2008/009199, filed on Oct. 31, 2008.

(30) Foreign Application Priority Data
Nov. 2, 2007 (DE) 10 2007 052 500.3

(51) Int. Cl. B01D 59/44

(52) U.S. Cl. 250/282; 250/288

(57) ABSTRACT

Method for detecting at least one target substance, including converting molecules of at least one of the target substances to a gaseous state and a spectrometric detection of the molecules. The object is to significantly increase the resolving capacity of the method in its detection limit and in its selectivity. This is achieved in that the conversion includes soluble mixing, formation of aerosol and evaporation of at least one of the target substances with a solvent, the molecules being integrated into a gas phase, and the spectrometric detection includes an ionisation of the molecules in the gas phase to form ions.

### CROSS-REFERENCE TO RELATED APPLICATION

This application is a continuation of PCT International Application No. PCT/EP2008/009199 filed Oct. 31, 2008, which claims the benefit of German Patent Application No. 10 2007 052 500.3, filed Nov. 2, 2007, the entire disclosure of which is herein incorporated by reference.

### FIELD OF THE INVENTION

The invention relates to a method and a device for detecting at least one target substance according to the first and the tenth claim respectively.

Detection of the aforementioned type involves detecting all or a portion of the substances which can be converted from a mixture as molecules to a gaseous state, are ionised and supplied to a subsequent detection in a mass spectrometer. Mass spectrometers are sufficiently well known in various designs for the analysis of chemical substances made up of gases or of dusts.

U.S. Pat. No. 6,797,944 discloses a laser desorption method in which substances are molecularly or atomically desorbed under the action of a pulsed infrared light from a surface for transferring to a chemical analysis system such as a mass spectrometer, for example. The pulse duration and pulse repetition rate allow specific substances to be selectively desorbed.

Furthermore. WO 05/047848 describes a method in which a solution is evaporated with a target substance in a microchannel structure and supplied with a carrier gas for ionisation to a corona zone. The ions are subsequently detected.

However, detection of a large number of target substances in a mixture requires not only a significantly increased selectivity of the method used, but also extended detection limits.

### SUMMARY OF THE INVENTION

Starting therefrom, the object of the invention is to propose a method and a device for detecting at least one target substance which is distinguished from the prior art by a significantly increased resolving capacity in its detection limit and in its selectivity.

The object is achieved by a method and a device having the features of claims 1 and 10 respectively. The sub-claims dependent thereon reproduce advantageous configurations.

The invention concerns a method for detecting at least one target substance and a device for carrying out the method.

The method includes converting molecules of at least one of the target substances to a gaseous state and a subsequent spectrometric detection of the molecules, preferably with the aid of a mass spectrometer.

A basic feature is the fact that the conversion of the molecules includes soluble mixing, formation of aerosol and evaporation of at least one of the target substances with a solvent, the molecules being integrated into a gas phase.

The soluble mixing of the molecules includes dissolving the target substance or substances into a solvent; this presupposes that the target substance is soluble with the solvent in the liquid and/or gaseous state. Only within an advantageous configuration does this rule out emulsification or dispersion of a portion of the target substance into the solvent. In this case, merely selective soluble mixing of a portion of the target substance is carried out, whereas the remaining other portion of the target substances is insoluble with the solvent and accordingly is not molecularly distributed in the solvent. In a further preferred form, temperature-dependent solubilities of a target substance with the solvent are utilised in a targeted manner, this target substance being incorporated into the solvent solely as a result of the selection and setting of a specific mixing temperature between a soluble and an insoluble, for example emulsifying, incorporation.

A further advantageous configuration includes soluble mixing of one or more target substances with the solvent in the presence of an additional carrier substance, the carrier substance preferably being soluble as particles or as a liquid in the solvent and adsorbing the molecules. The adsorption is preferably carried out prior to the mixing. During the mixing, the adsorbed target substances are then transported via the dissolving carrier substances in the solvent, distributed homogeneously, preferably as molecules or groups of molecules, and thus ideally molecularly incorporated even in the case of insolubility with the solvent.

Mixing is preferably carried out continuously by combining the target substances and the solvent. Micromixers, disclosed by way of example in DE 199 28 123 A1, promote in an advantageous manner continuous spontaneous simultaneous mixing of two liquids.

Furthermore, additionally equipping the mixing device with a separating device, such as for example HPLC (device for high performance liquid chromatography) or electrophoretic separating devices (based on capillary electrophoresis, for example) for separating a plurality of target substances before or after the mixing with the solvents, is an additional embodiment.

The invention also includes the use of a plurality of solvents, one or more target substances preferably being incorporated separately into each solvent and the solutions which are produced subsequently being combined.

The soluble mixing is accompanied or followed by a formation of aerosol in which the target substances are atomised with the solvent or solvents to form an aerosol.

A further basic feature of the invention includes the formation of aerosol by an aerosol former. Preferably, this is carried out by way of the formation of droplets by means of a dispenser, wherein a predefined number of droplets preferably having a constant droplet size (10 to 200 pl, preferably 20 to 100 pl, more preferably between 30 and 80 pl, more preferably 40 to 60 pl in volume) and substance mixture ratio (target substances and solvents) can be generated, or together with mixing by means of a two or multiple-component nozzle. Dispensers are suitable both for atomisation of the solution after mixing and also by separate atomisation of the solvents and target substances to be mixed into a common cloud of aerosol. The invention includes promoting the formation of aerosol by carrying out additional measures on the aerosol former, for example by applying ultrasonic waves to the liquid or solution to be dispersed or by electric charges (electrospray), similarly electrically charged liquid particles not only repelling one another, but also being electrically attracted in an electric field to a counter electrode, such as by a heating element in the aforementioned evaporation device, for example.

Alternatively, aerosol can also be formed as a result of the bursting of bubbles via a device in which an effervescing, boiling or otherwise gas bubble-forming liquid, comprising solvent and all or only a portion of the target substances, is arranged in an open vessel. The gas bubbles formed rise to the surface of the liquid where they burst, the surface of the bubbles, the tension of which is relieved in the process, releasing drops of aerosol. The target substances in the liquid are incorporated during the formation into the gas volumes or to the liquid interfaces of the bubbles that border the gas volumes, from where they are released with the solvent as drops of aerosol into the ambient atmosphere during the bursting. Additional substances in the solution, such as surface-active substances (for example surfactants, foaming agents) having possible structure-specific affinities to the target substance, influence or promote selective concentration of the target substances in the bubbles and in the droplets produced when the bubbles burst. Likewise, an optional direct evaporation of the foam at the preheated heating element surface may also be used for targeted enrichment and measurement of the target substances.

A further basic feature of the invention includes evaporation of the solvent, which is in aerosol form, with the target substance or substances. The evaporation is preferably carried out thermally on a heating element surface having a surface temperature preferably above the boiling temperature of the solvent, the target substances preferably being transported molecularly by the solvent gases and propagating in gaseous form. If the surface temperature is below the boiling temperature of one of the target substances, aerosol components (i.e. no individual molecules or groups of molecules) are selectively not evaporated, or evaporated significantly more slowly, from this target substance, remain on the heating element surface for longer, for example, and are in this way kept away or separated from the gas phase which is formed. This effect can also be utilised for selective enrichment of a specific target substance on the heating element surface, for example. Pulsewise heating for evaporation allows the enriched target substances to be converted to the gas phase, so they are advantageously available in concentrated form for further analysis, for example in a mass spectrometer. This allows not only the detection limits of specific target substances to be lowered, but also a material separation of target substance groups to be implemented, in particular in the case of a large number of target substances.

An increased integral tendency to adhesion, or a tendency to adhesion aimed selectively at at least one of the target substances, can be achieved by treating or coating the heating element surface. For example, a functional coating comprising nanoparticles or a polymer adsorption coating (containing or consisting of nanoparticles or a chemical polymer adsorption coating) allows concentration of the target substances having an increased tendency to adsorption. The target substances which are concentrated over a specific time can also be quantitatively detected on the coated or treated heating element surface as a self-contained sample in a further analysis method.

An aerosol produced by bursting of gas bubbles rising in liquid is evaporated preferably by a heating element arranged above the surface of the liquid. The heating element surface is preferably arranged horizontally.

A further embodiment includes an open-pored heating element, the aerosol passing through the open pores and being evaporated in the process. The open-pored structure is formed in this case by the heating capillaries, the walls of which are the heating element surfaces and if appropriate are coated or treated in the above-mentioned sense. The aerosol is drawn in through the heating capillaries as a result of reduced-pressure suction. In the embodiment in which aerosol is formed by rising bursting gas bubbles, the open-pored heating element is preferably arranged in a plate-like manner above the surface of the liquid.

The invention also includes ionisation and means for ionising molecules or groups of molecules of the target substance in the gas phase to form ions. The ionisation is carried out preferably as photoionisation, preferably with a laser light, VUV or UV source. In a preferred embodiment, the laser light, VUV or UV source is used not only for photoionisation, but also for integrally or locally heating the heating element surface, either as a stand-alone or as an additional energy source.

The invention also includes a spectrometric detection and a mass spectrometer for carrying out this detection.

The invention includes using the method and the device for quantitatively detecting specific biological or biochemical substances such as axerophthenes, retinols, terpineols, citrals, geranyl acetates, nootkatones, bisabolenes or decanes as the target substance in absolute form or made up of a mixture of substances, wherein the heating element surfaces can also be formed by natural or processed sample surfaces through to plant parts or tissue samples and can be heated by being irradiated with light, for example. The detection includes in vitro tests carried out on body fluids and in situ tests.

### BRIEF DESCRIPTION OF THE DRAWINGS

The invention will be described hereinafter in greater detail with reference to embodiments and the figures, in which:

FIG. 1 shows a first embodiment with an uncoated heating element;

FIG. 2 shows a second embodiment with a coated heating element;

FIG. 3 shows a third embodiment with rising gas bubbles which burst at a surface of the liquid to form aerosol;

FIG. 4a to c show further embodiments with suction capillaries to a mass spectrometer;

FIG. 5 shows an embodiment with an evaporating device with a laser scanner;

FIG. 6 shows a mass spectrum, determined within the scope of the invention, for a drop of a 1 mg/l solution of D10 pyrene in methanol; and

FIG. 7a to c each show a mass spectrum, determined within the scope of the invention, of a 10 mg/l standard HCL solution at an evaporation temperature of 80 ° C. (a), 100 ° C. (b) and 102° C. (c).

### DESCRIPTION OF EXEMPLARY EMBODIMENTS

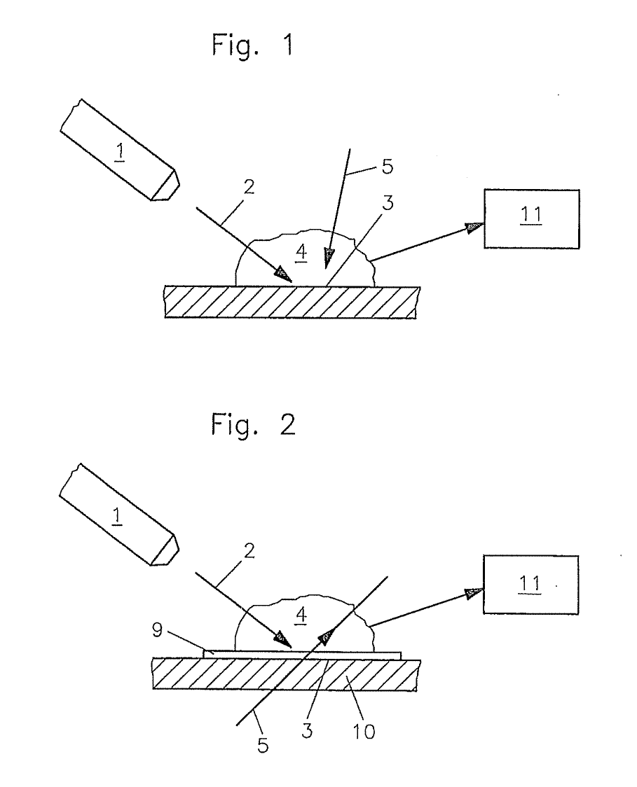

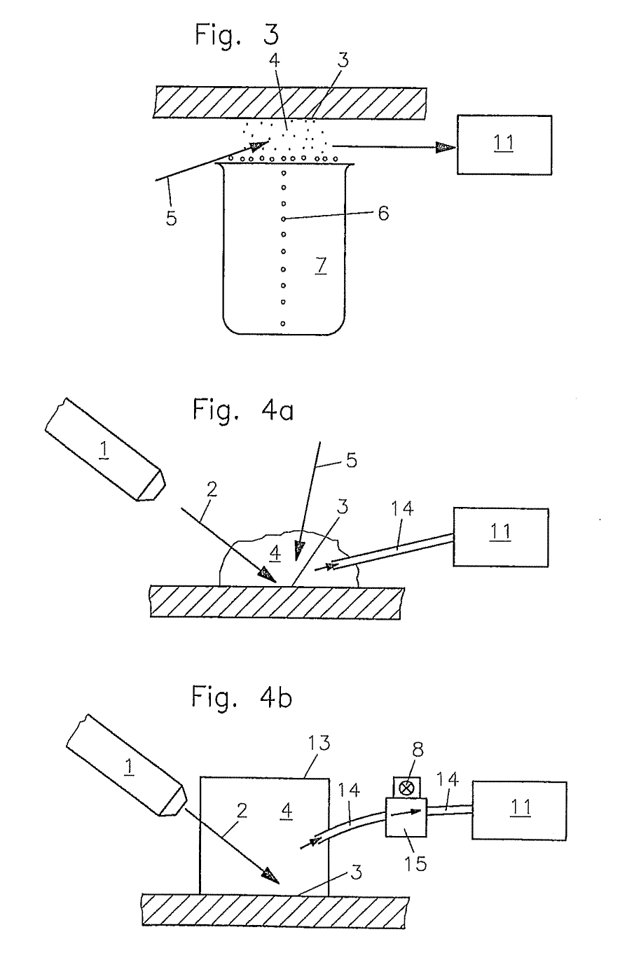

As shown in FIGS. 1 to 5, the embodiments of a device for detecting at least one target substance comprise a dispenser 1 (FIGS. 1, 2, 4 and 5) or a liquid 7 forming gas bubbles 6 (FIG. 3) as an aerosol former which is oriented with its main jet direction 2 of the aerosol onto the heating element surface 3. When the aerosol strikes the heating element surface 3, evaporation produces a gas phase cloud 4 which is then irradiated with a light beam 5 from a laser, UV or VUV source 8 and ionises the molecules of the target substances. The ionised molecules are extracted from the gas phase cloud and transferred to a mass spectrometer 11.

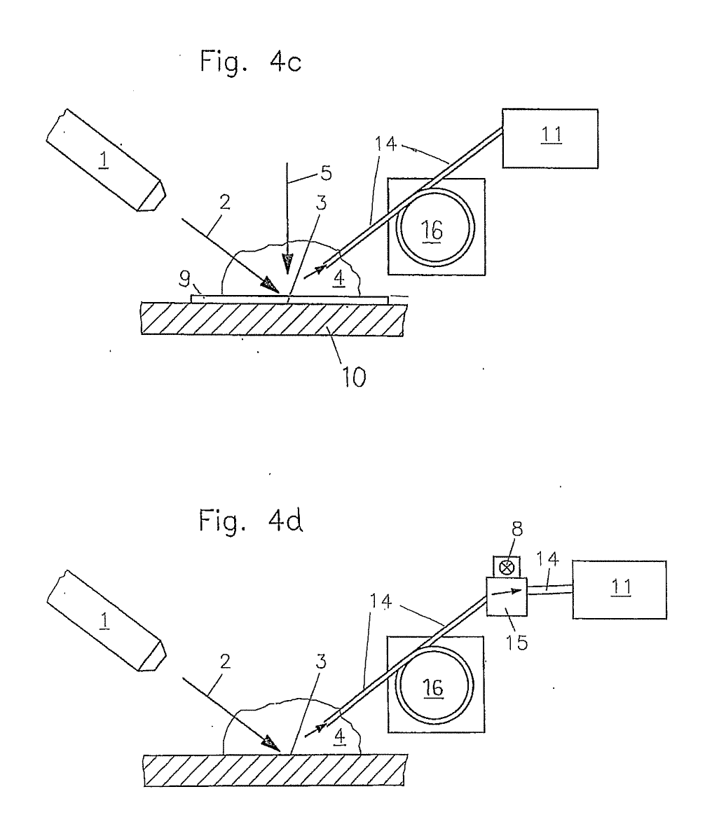

FIG. 2 shows by way of example a coating 9 on the heating element 10, for example one of the aforementioned functional coatings comprising nanoparticles (cf. FIG. 4c and d). The heating element surface 3, i.e. the surface that is exposed to the aerosol for evaporation, is thus heated indirectly through the coating.

FIGS. 1, 4a and 5 show embodiments in which the light beam 5 is aimed at the heating element surface 3 and can be used as a stand-alone or additional heater for the evaporation. In these cases, they are also part of the evaporation device.

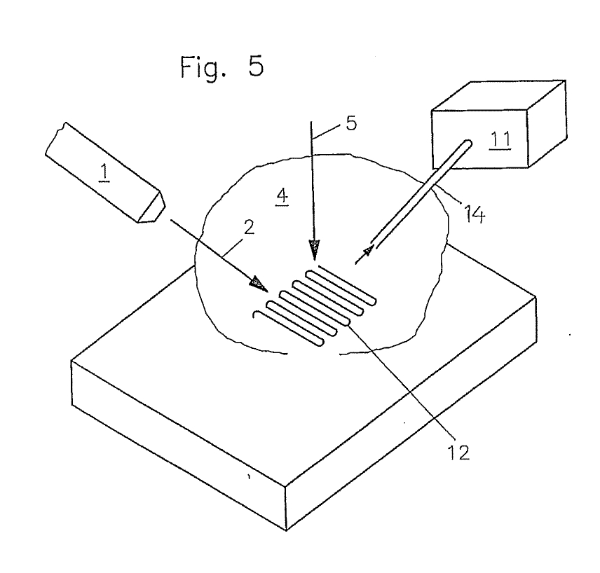

FIG. 5 represents an embodiment in which the light beam 5 on the heating element surface follows a line-by-line scanning movement 12 and thus, in a time-resolved manner, brings onto the surface regions for evaporation only the substances to which solvent is directly applied. An embodiment of this type is preferably suitable for adsorption tests of target substances on a natural or finished surface having a plurality of different surface regions as the heating element surface. The heating elements are preferably heated exclusively by the light beam.

FIG. 4a to c show by way of example devices in which the molecules in the gas phase are drawn in through a capillary 14 and transferred to the mass spectrometer 11. FIG. 4a (cf. also FIG. 5) shows an embodiment in which the capillary ends in the gas phase cloud 4, preferably at or as close as possible to the point on the heating element at which the gas phase is produced by evaporation. In contrast to all the other systems shown. FIG. 4b shows by way of example an embodiment with an evaporation chamber 13 (closed system). Furthermore, the capillary 14 can be provided, on its path to the mass spectrometer 11, with an ionisation chamber 15 having ionising means such as a laser, UV or VUV source 8 (cf. FIG. 4b), for example, and/or with a GC capillary 16 (cf. FIG. 4c). In principle, series connection of the two aforementioned ionisation chambers and GC capillaries in the capillary is possible in any desired order. However, the effectiveness of a GC capillary is also dependent on ionisation of the transferred substances, reproducibility of a separation of substances being ensured in the case of non-ionised substances, in particular. A preferred embodiment therefore includes a capillary 14 with an integrated ionisation chamber 15 and GC capillary 16, the ionisation chamber being connected downstream of one or more GC capillaries and connected directly upstream of the mass spectrometer 11 (cf. FIG. 4d).

However, in principle, ionisation of molecules at two points, i.e. such as for example both at the heating element surface (cf. FIGS. 1, 2, 3, 4a, 4c and 5) and in a separate ionisation chamber (cf. FIGS. 4b and 4d), in particular in combination with other separating devices such as a GC capillary, for example, can also be used for optimising the selectivity of the method for specific target substances.

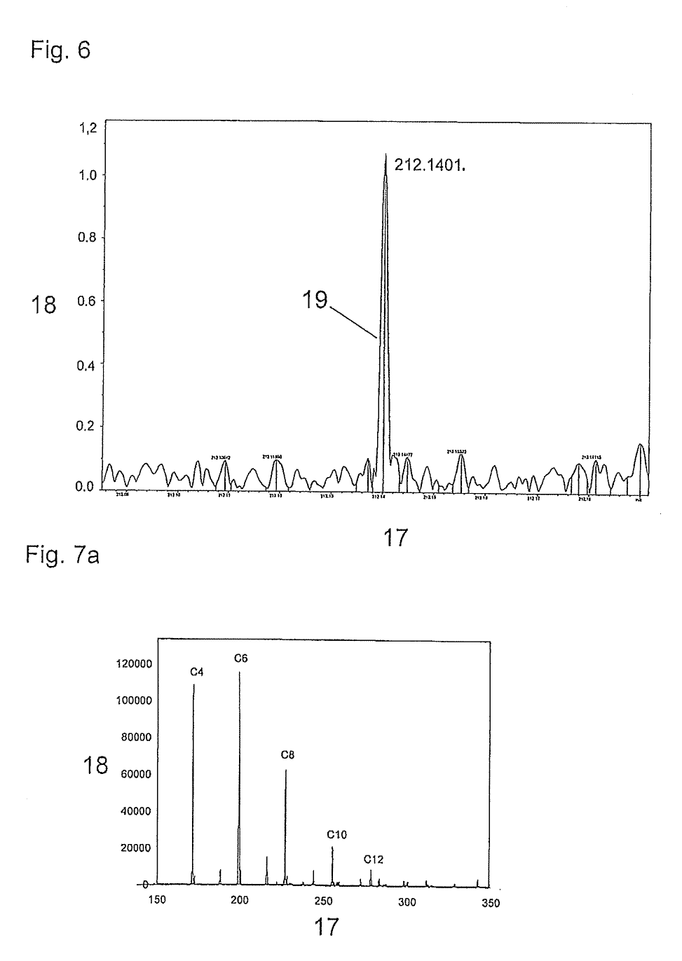

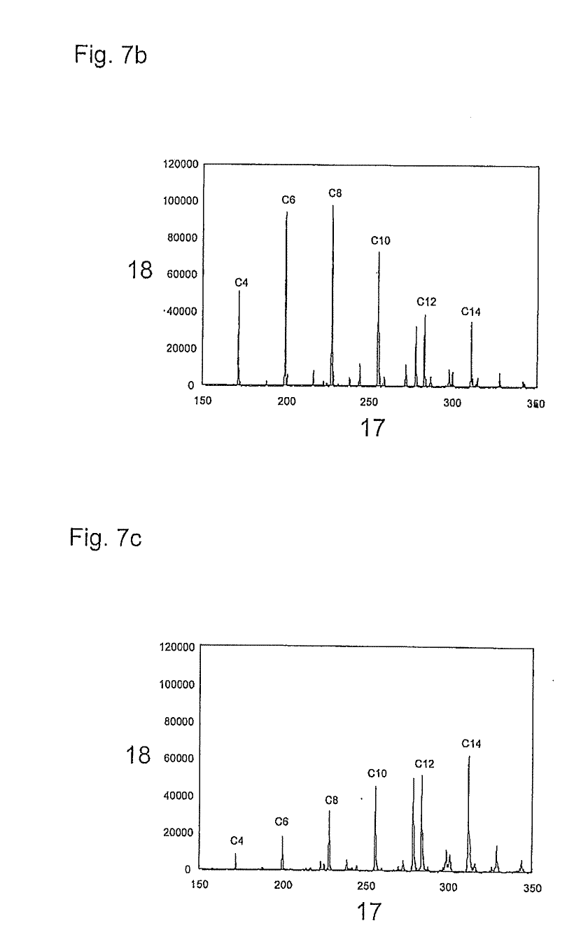

FIGS. 6, 7a to c and 8 represent by way of example mass spectra, i.e. the intensities 18 plotted over the mass-to-charge ratio 17, such as were determined in tests within the scope of the invention. The solvents used for the tests are commercially available products of analytical quality.

The spectrum illustrated in FIG. 6 represents the sensitivity of the method. It was determined on a device according to FIG. 1, with laser ionisation, i.e. with evaporation of individual drops (drop volume 52.5 pl) by a dispenser on an uncoated heating element surface. The result represents the resolution of a single drop of a solution of 1 mg/l of D10 pyrene in methanol as peak 19. This peak towers significantly above the signals surrounding it even in the evaluation of one drop; the method displays high sensitivity, i.e. a low detection limit.

It is possible to considerably speed up a determination of a spectrum according to FIG. 6 by rapid separation using a UPLC (ultra performance liquid chromatography, HPLC high performance liquid chromatography) installation as follows. The starting product was in this case a mixture of a plurality of polycyclic aromatic hydrocarbons (PAHs) which were firstly supplied to the UPLC separation. The separated PAHs to be examined were then incorporated at a mixing ratio of between 30 and 100% into acetonitrile at a flow rate of 0.9 ml/Min for 0.5 min, followed by an isocratic flow (100% acetonitrile) for 0.2 min for homogenisation. In this way, it was possible within 1.2 min to isolate a 52.5 pl D10 pyrene fraction (one drop) from a total starting product fraction of 1,080 pl, to add it using a dispenser, for example, to ionise it using a UV source of the type mentioned at the outset, to detect it using an ICR-FT mass spectrometer and to determine a spectrum according to FIG. 6.

The aforementioned procedure is distinguished by a gentle feeding and treatment of the biomolecules, on the one hand, and the isolation of the substance in a very short time, on the other hand, and thus also allows the detection of even atmosphere-sensitive or otherwise sensitive substances, for example, for the identification of metabolites (metabolomics), breathing air condensates, liquor cerebrospinalis (cerebrospinal fluid) or microbiopsy samples. The risk of thermal decomposition during the ionisation of the molecules is thus reduced, as is fragmentation of the substances to be examined. The quantity of samples, which is basically low, required for a reliable analysis allows important future applications such as for example microtechnical analysis systems (LabOnChip), including for example separation of substances in fluidic chips over the narrowest space or at high throughputs for isolating trace constituents at very low concentrations. The very high separating power in a very short time and the required demand for analytes after the separation in the picolitre range are, in particular, advantageous.

FIGS. 7a to 7c, on the other hand, show spectra, also determined in a device according to FIG. 1, but with UV ionisation. 80, 100 and 120 ° C. (cf. FIG. 7a, b and c respectively) were selected as evaporation temperatures on the heating element surface. The solution used as the model substance consisted of 10 mg/l of N-acyl homoserine lactone (HSL) comprising carbon chains having a chain length of 4, 6, 8, 10, 12 and 14 carbon atoms (as c4 to c14 in FIG. 7a to c) in methanol, wherein the contents of the respective chain lengths in the solution were identical in all three tests. HSLs are signal substances which play an important part in the interbacterial communication of certain bacteria. Selectivity, predefined by the temperature of the heating element surface, of the HSLs as a function of the chain length is clearly apparent in the spectra determined. Whereas short-chain HSLs, in particular the c4 and c6 HSLs, predominate mainly at evaporation temperatures of up to 100° C. (cf. FIG. 7a and b), they are eclipsed by the longer-chain c12 and c14 HSLs at 120° C. (cf. FIG. 7c). Whereas c14 HSL is barely apparent at 80° C. (cf. FIG. 7a), at 120° C. it forms the highest peak. This test example illustrates the possibility of controlling the selectivity based on the example of a temperature dependence of a solution comprising a plurality of target substances. In this case, elevated temperatures increasingly evaporate even the larger molecules of more highly polar target substances, whereas short-chain target substances display lower thermal stability and volatilise even at relatively low temperatures. This selectivity may also be utilised for containment of initially unknown target substances in a solution.

### LIST OF REFERENCE NUMERALS

1 dispenser
2 main jet direction
3 heating element surface
4 gas phase cloud
5 light beam
6 gas bubble
7 liquid
8 VUV source
9 coating
10 heating element
11 mass spectrometer
12 scanning movement
13 evaporation chamber
14 capillary
15 ionisation chamber
16 GC capillary
17 mass-to-charge ratio
18 intensity
19 peak of D10 pyrene

1. A method for detecting at least one target substance, with the following method steps:
converting molecules of at least one of the target substances to a gaseous state, wherein the converting to the gaseous state includes soluble mixing, formation of aerosol and evaporation of at least one of the target substances with a solvent, the molecules being integrated into a gas phase, and all or only a portion of the target substances being dissolved in a liquid as a solvent in which gas bubbles having gas volumes are formed, the target substance being incorporated during the formation into the gas volumes or at the liquid interfaces bordering the gas volumes and the aerosol being formed as a result of the gas bubbles bursting at the surface of the liquid; and
spectrometric detection of the molecules, the molecules being ionised in the gas phase.

2. The method according to claim 1, wherein only a portion of the target substances are mixed selectively with the solvent, the remaining portion of the target substances being insoluble with the solvent.

3. The method according to claim 1, wherein the molecules of the target substance are mixed with an additional carrier substance prior to the mixing with the solvent, the carrier substance being soluble with the solvent and adsorbing the molecules.

4. The method according to claim 1, wherein the evaporation is carried out on a heating element surface having a surface temperature above the boiling temperature of the solvent.

5. The method according to claim 4, wherein the surface temperature does not exceed the boiling temperature of at least one target substance.

6. The method according to claim 4, wherein, on the heating element surface, at least one of the target substances is bound on as a result of an increased tendency to adhesion.

7. The method according to claim 1, wherein the ionisation is carried out by means of photoionisation during and/or after the evaporation, the target substances and the solvent also being irradiated by a laser light, VUV or UV source immediately before and after the evaporation.

8. The method according to claim 7, wherein the energy required for the evaporation is input by the laser light, VUV or UV source.

9. The method according to claim 1, including transferring the evaporated target substances and the solvents to an ionisation chamber in which the target substances and the solvent are ionised under irradiation by a laser light, VUV or UV source only after the evaporation.

10. A device for detecting at least one target substance for carrying out a method according to claim 1, with:
a mixing device, an aerosol former and an evaporation device for the solvent and molecules of at least one of the target substances, wherein the mixing device and the aerosol former comprise a device for the formation of aerosol as a result of the bursting of bubbles;
a laser light, VUV or UV source for photoionisation of the molecules to form ions; and
a mass spectrometer for spectrometric detection of the ions.

11. The device according to claim 10, wherein the evaporation device comprises a heating element surface.

12. The device according to claim 11, wherein the heating element surface has a functional coating comprising nanoparticles or a polymer adsorption coating for the concentration of target substances.

13. The device according to claim 10, wherein the evaporation device comprises a natural or a processed surface of a sample with heating means.

14. The device according to claim 13, wherein the heating means comprise a laser light, VUV or UV source.

15. The device according to claim 10, wherein the mass spectrometer has a suction capillary directed toward the evaporation device.

16. The device according to claim 15, wherein the suction capillary comprises a gas chromatograph.

17. The device according to claim 15, wherein the suction capillary discharges into a closed-off ionisation chamber comprising the laser light, VUV or UV source.

18. The device according to claim 10, wherein the mixing device comprises an HPLC or an electrophoretic separating device.
